(19) United States
(12) Patent Application Publication
(10) Pub. No.: US 2013/0293463 A1
(43) Pub. Date: Nov. 7, 2013

(54) REPEATED EMPHASIS OF A USER INTERFACE COMPONENT

(71) Applicants: COLIN CHARLES STONE, Winchester (GB); Joseph Robert Winchester, Winchester (GB)

(72) Inventors: COLIN CHARLES STONE, Winchester (GB); Joseph Robert Winchester, Winchester (GB)

(73) Assignee: INTERNATIONAL BUSINESS MACHINES CORPORATION, Armonk, NY (US)

(21) Appl. No.: 13/461,352

(22) Filed: May 1, 2012

(51) Int. Cl. G09G 5/08; G09G 5/00

(52) U.S. Cl. 345/157; 345/156

(57) ABSTRACT

A method for repeated emphasis of a component in a user interface may include selecting, by a processor, at least one component in a user interface for target emphasis for performance of a repeated emphasis. The method may also include performing, by the processor, the repeated emphasis on the at least one selected component. Performing the repeated emphasis may include automatically, repeatedly performing an action associated with the selected component without a user input, wherein each action would require the user input without the repeated emphasis being performed.

### BACKGROUND

Aspects of the present invention relate to graphical user interfaces, and more particularly to a method, system and computer program product for repeated emphasis or targeted emphasis of a component in a user interface.

Obtaining continual updates from a component of a system in a controlled manner is often desirable when interacting with a system to observe dynamic feedback. For example, a switch may need to be turned on and off or another mechanism may need to be operated by a user to reach a specific state or to refresh a webpage displaying sports scores or other information that may be dynamically changing over time. Each of these activities requires a repeated action by the user. In another example, a user may repeatedly submit a job or cause a particular routine to be performed over and over to cause statistics or other data to be refreshed in a way that allows the user to understand changing trends or thresholds being reached.

In a graphical user interface (GUI), a button or other mechanism is typically operated by the user to refresh the GUI or to submit data entered into the GUI. This activity requires that the attention of the user be refocused and distracts the user from observing the object or information of interest. Additionally, when the user is required to repeatedly perform an action, the information provided is a snapshot and may not provide any idea of trends or the dynamic nature of the changing values that may be critical in assessing the information provided to the user.

### BRIEF SUMMARY

According to an aspect of the present invention, a method for repeated emphasis of a component in a user interface may include selecting, by a processor, at least one component in a user interface for target emphasis for performance of a repeated emphasis. The method may also include performing, by the processor, the repeated emphasis on the at least one selected component. Performing the repeated emphasis may include automatically, repeatedly performing an action associated with the selected component without a user input, wherein each action would require the user input without the repeated emphasis being performed.

According to another aspect of the present invention, a system for repeated emphasis of a component in a user interface may include a processor and an application operating on the processor. The application may include a module for selecting at least one component in a user interface for target emphasis for performance of a repeated emphasis. The application may also include a module for performing the repeated emphasis on the at least one selected component. Performing the repeated emphasis may include automatically, repeatedly performing an action associated with the selected component without a user input, wherein each action would require the user input without the repeated emphasis being performed.

According to a further aspect of the present invention, a computer program product for repeated emphasis of a component in a user interface may include a computer readable storage medium having computer readable program code embodied therewith. The computer readable program code may include computer readable program code configured to select at least one component in a user interface for target emphasis for performance of a repeated emphasis. The computer readable program code may also include computer readable program code configured to perform the repeated emphasis on the at least one selected component. Performing the repeated emphasis may include automatically, repeatedly performing an action associated with the selected component without a user input, wherein each action would require the user input without the repeated emphasis being performed.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A and 1B (collectively FIG. 1) are a flow chart of an example of a method for repeated emphasis of a component in a user interface in accordance with an embodiment of the present invention.

FIG. 2 is a flow chart of an example of a method for repeated emphasis of a component in a user interface in accordance with an embodiment of the present invention.

FIGS. 3A-3C are an illustration of an example of repeated emphasis of a component in a user interface in accordance with an embodiment of the present invention.

FIGS. 4A-4G are an illustration of another example of repeated emphasis of a component or components in a user interface in accordance with an embodiment of the present invention.

FIG. 5 is a block schematic diagram of an example of a system for repeated emphasis of a component in a user interface in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In accordance with an embodiment of the present invention, a repeated emphasis or targeted emphasis feature or application is provided that allows a user to obtain or observe dynamic feedback from a selected component or components in a user interface and to make judgments based upon the way the data or information may be changing each time a process or job is resubmitted or refreshed and the results presented. The repeated emphasis or targeted emphasis feature or application provides a mechanism that automatically resubmits or refreshes the process or job associated with the user interface without user input which would be required to resubmit or refresh the process or job without the repeated emphasis or targeted emphasis mechanism of the present invention. Accordingly, the repeated emphasis or targeted emphasis feature or mechanism eliminates the need for a user to have to continually operate a button or other mechanism to resubmit or refresh a process or job which may distract the user's attention from observing the way the results are changing in response to each resubmit or refresh operation. The user may also not be able to physically operate the mechanism at a speed or frequency or at exact uniform intervals to observe the results of the process or job under such conditions.

A data view will normally have a contextual component that describes the data on display and the time the data was last refreshed. The component may be configured to accept repeated emphasis or targeted emphasis. When the repeated or targeted emphasis is enabled or received in association with the component, a predefined or pre-configured activity associated with the repeated emphasis may be performed in association with the component until the repeated emphasis is removed. The targeted emphasis may be applied or associated with a component by “parking” or “hovering” a computer pointing device, mouse pointer or other mechanism over the component. A hot-key or other device may also be used to select the component, associate or apply the predefined activity and enable and disable states for the repeated or targeted emphasis to perform the predefined activity in association with the selected component. The contextual component will echo the result of each repeated operation and content within the user interface as the user interface is automatically continually refreshed. For accessibility purposes selection can be moved to a specific cell or element in the user interface for presenting the updates to the user.

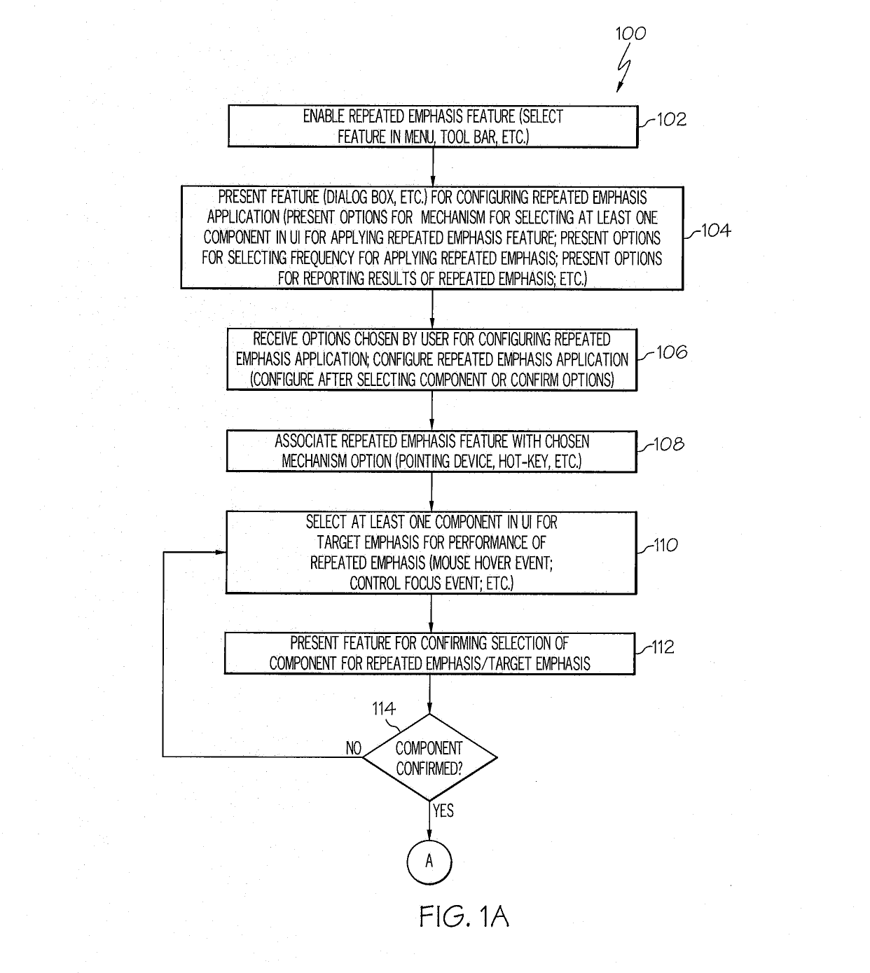

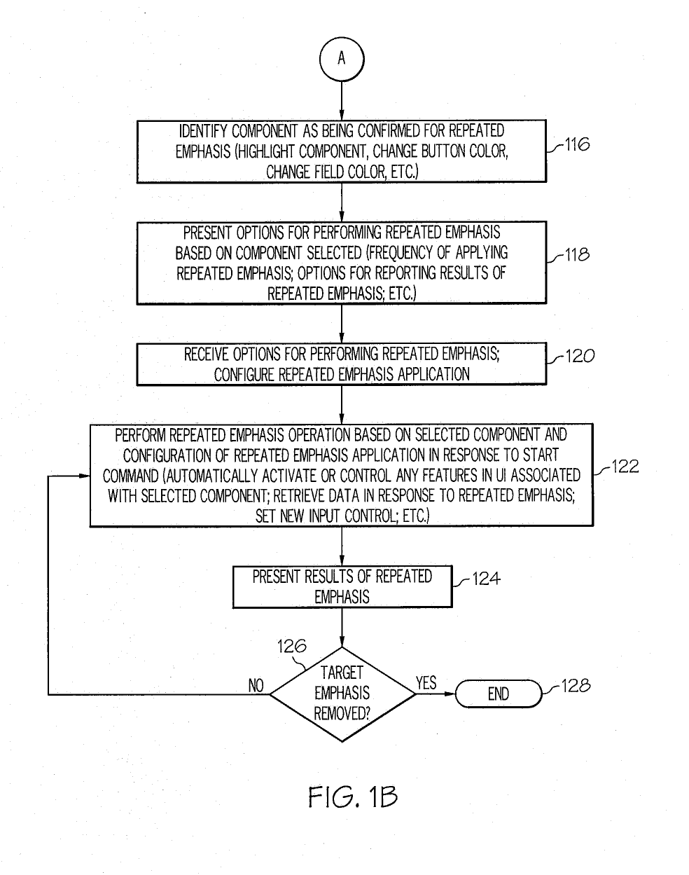

FIGS. 1A and 1B (collectively FIG. 1) are a flow chart of an example of a method 100 for repeated emphasis of a component in a user interface in accordance with an embodiment of the present invention. In block 102, a repeated emphasis feature or target emphasis feature may be enabled. The repeated emphasis feature may be enabled by selecting a feature in a menu, toolbar, or by any other mechanism that may be used for activating a feature or application on a computing device.

In block 104, a feature may be presented for configuring a repeated emphasis application. The feature for configuring the repeated emphasis application may be a dialogue box or similar arrangement for configuring operation of the repeated emphasis application as described herein. In accordance with an embodiment of the present invention, options for performing the repeated emphasis may be selected after selecting a component in a user interface for target emphasis for performance of a repeated emphasis operation.

Examples of configuring the repeated emphasis application may include but is not necessarily limited to choosing a mechanism for selecting at least one component in the user interface or graphical user interface for applying the repeated emphasis feature or operation; presenting options for selecting or entering a frequency or interval for applying repeated emphasis; and presenting options for reporting results of repeated emphasis. For example, the results may be presented or updated after performance of each repeated emphasis or operation, or the results may be updated at a chosen interval relative to each repeated emphasis operation.

Examples of mechanisms for selecting at least one component may include, but is not necessarily limited to a computer pointing device, a hot-key or a designated key on a keyboard or keypad for enabling or disabling operation of the repeated emphasis feature or any other means for selecting a component in a graphical user interface.

In block 106, the options chosen by the user for configuring the repeated emphasis application may be received and the repeated emphasis application may be configured based on the choices of the user. As previously discussed, the repeated emphasis application may also be configured after selecting the component for repeated emphasis as described in more detail with reference to block 120. The options for configuring the repeated emphasis may be also be confirmed after selecting the component and other options or different options may be chosen depending on the nature of the component to which the repeated emphasis operation is to be performed or so that the user may observe repeated emphasis based on a particular set of parameters.

In block 108, the repeated emphasis feature may be associated with the mechanism chosen for selecting the component in the user interface on which repeated emphasis is to be performed.

In block 110, at least one component may be selected in a user interface for target emphasis for performance of a repeated emphasis. The at least one component may be selected by positioning a computer pointing device over the component in the user interface, by operation of a hot-key associated with the component, or by any other mechanism that may be used to select a component in a user interface for performing the repeated emphasis operation in association with the component.

As described in more detail herein, performing the repeated emphasis may include automatically, repeatedly performing an action associated with the selected component without a user input, wherein each action would require the user input or an action by the user if the repeated emphasis were not being performed. Accordingly, when the repeated emphasis is applied to the selected component the user does not need to continually operate a button or other mechanism to refresh or submit data in the user interface. Therefore, the user does not need to refocus his attention each time the button or other mechanism is operated and the user is not distracted from observing the results from operation of the button or other mechanism associated with the component in the user interface. The user can then observe any trends or the dynamic nature of the changing values that may be critical in assessing the information provided to the user.

In block 112, a feature may be presented for confirming selection of the component for repeated emphasis or target emphasis. For example, a dialogue box or other arrangement may be presented for the user to confirm selection of the component for repeated emphasis.

In block 114, a determination may be made if the selection of the component for repeated emphasis was confirmed. If the component was not confirmed, the method 100 may return to block 110 and the method 100 may proceed similar to that previously described. If selection of the component in the user interface for repeated emphasis is confirmed in block 114, the method 100 may advance to block 116.

In block 116, the component may be identified as being confirmed for repeated emphasis. The component may be highlighted or distinguished from other components in the user interface in some manner to identify the component as being confirmed for repeated emphasis. Examples of identifying, highlighting or distinguishing the selected component may include changing a color of the component, button or other mechanism, changing a color of a field in which data or information may be inserted or any other arrangement for distinguishing the selected component from other non-selected components in the user interface.

In block 118, options may be presented for performing the repeated emphasis based on the component selected. Similar to that previously discussed, in another embodiment, the options for performing the repeated emphasis may be chosen prior to selecting the component to which the repeated emphasis is to be applied or perform. In a further embodiment, the repeated emphasis application may be configured to choose the options for performing the repeated emphasis either prior to or after selecting the component to which the repeated emphasis is to be applied or perform. If the options are selected prior to selecting the component, the user may confirm the options previously selected and may select other options for performing the repeated emphasis. Options for performing the repeated emphasis may include but is not necessarily limited to a frequency of applying the repeated emphasis; options for reporting results of the repeated emphasis; and any other parameters associated with the repeated emphasis of the selected component that may be desired by the user.

In block 120, the options for performing the repeated emphasis or target emphasis may be received and the repeated emphasis application may be configured based on the received options and the selected component.

In block 122, the repeated emphasis operation may be performed based on the selected component and configuration of the repeated emphasis application. Performance of the repeated emphasis operation may be started in response to a start command or other input from the user. Any features in the user interface associated with the selected component may be automatically activated or controlled by the repeated emphasis. Performing the repeated emphasis may include automatically, repeatedly performing an action associated with the selected component without a user input, wherein the action would normally not be performed without the repeated action of the user. Thus, the user's attention does not need to be refocused and the user is not distracted from observing the results of the repeated emphasis or target emphasis.

In block 124, the results of the repeated emphasis may be presented. As previously discussed, the user may configure the repeated emphasis application to present or update the results after each repeated emphasis operation or the results may be updated at a chosen interval relative to each repeated emphasis. For example, a predetermined number of repeated emphasis operations may occur before the results are updated and presented to the user.

In block 126, a determination may be made whether the target emphasis has been removed. For example the computer pointing device may be moved from being over the selected component or the hot-key or other designated key or mechanism may be operated to disable the repeated emphasis. If the target emphasis has not been removed, the method 100 may return to block 122 and the method 100 may proceed similar to that previously described. If the target emphasis has been removed, the method 100 may advance to block 128 and the method may end or be terminated. The target emphasis may also be moved to another component in the user interface for repeated emphasis or target emphasis similar to that previously described.

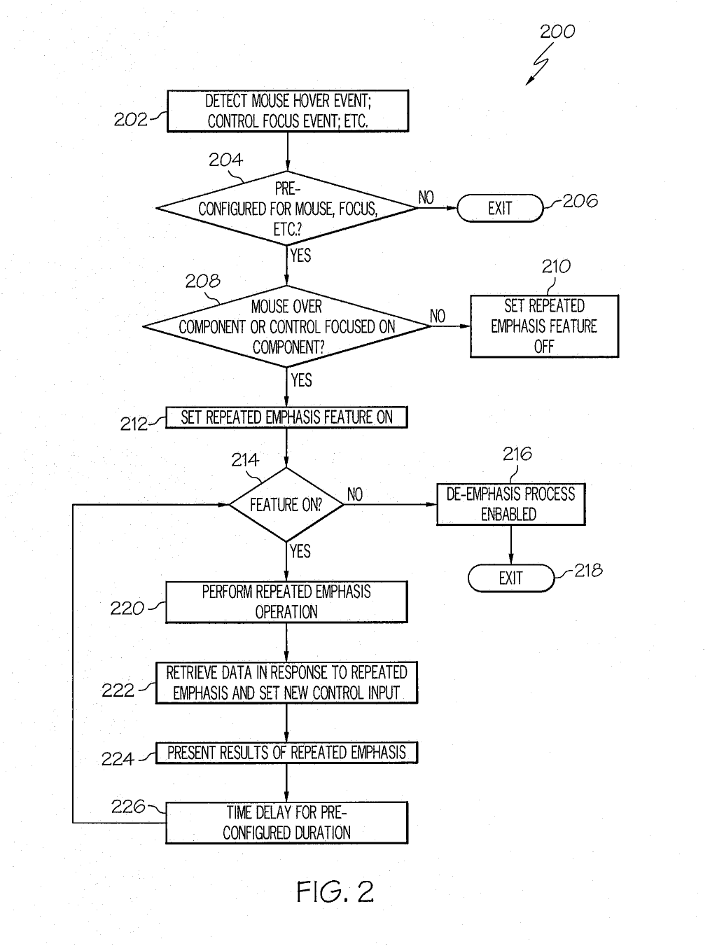

FIG. 2 is a flow chart of an example of a method 200 for repeated emphasis of a component in a user interface in accordance with an embodiment of the present invention. The method 200 may form part or parts of the method 100 in FIGS. 1A and 1B.

In block 202, a mouse hover event, a control focus event or other event for selecting a component in a user interface for repeated emphasis or target emphasis may be detected. A mouse hover event may include positioning a computer pointing device over the component being selected for repeated emphasis. A control focus event may include a hot-key or other designated key in a keyboard or keypad or other input device for selecting a component and choosing enablement and dis-enablement states of the selected component for performing repeated emphasis similar to that described herein.

In block 204, a determination may be made if the system has been preconfigured for selecting the component for repeated emphasis in response to either the mouse hover event or control focus event or some other event for selecting the component. If the system has not been preconfigured for selecting the component for repeated emphasis, the method 200 may exit at termination 206. If the system has been preconfigured for selecting the component for repeated emphasis, the method 200 may advance to block 208.

In block 208, a determination may be made if the mouse is hovering over a component or the control is focused on a component. If not, the method 200 may advance to block 210 and the repeated emphasis feature or operation may be set to off or inactive. If the mouse is hovering over a component or the control is focused on a selected component, the method 200 may advance to block 212.

In block 212, the repeated emphasis feature or operation may be set to on or active.

In block 214, a determination may be made if the repeated emphasis feature is on. If the repeated emphasis feature is not on, the method 200 may advance to block 216 and a de-emphasis process may be enabled. The method 200 may exit or terminate at block 218.

If the repeated emphasis feature is on in block 214, the method 200 may advance to block 220. In block 220, the repeated emphasis operation may be performed on the selected component in the user interface.

In block 222, data may be retrieved in response to the repeated emphasis and a new control input may be set.

In block 224, the results of the repeated emphasis may be presented to the user. In block 226, there may be a time delay for a preconfigured duration. The method 200 may then return to block 214 and the method 200 may proceed similar to that previously described.

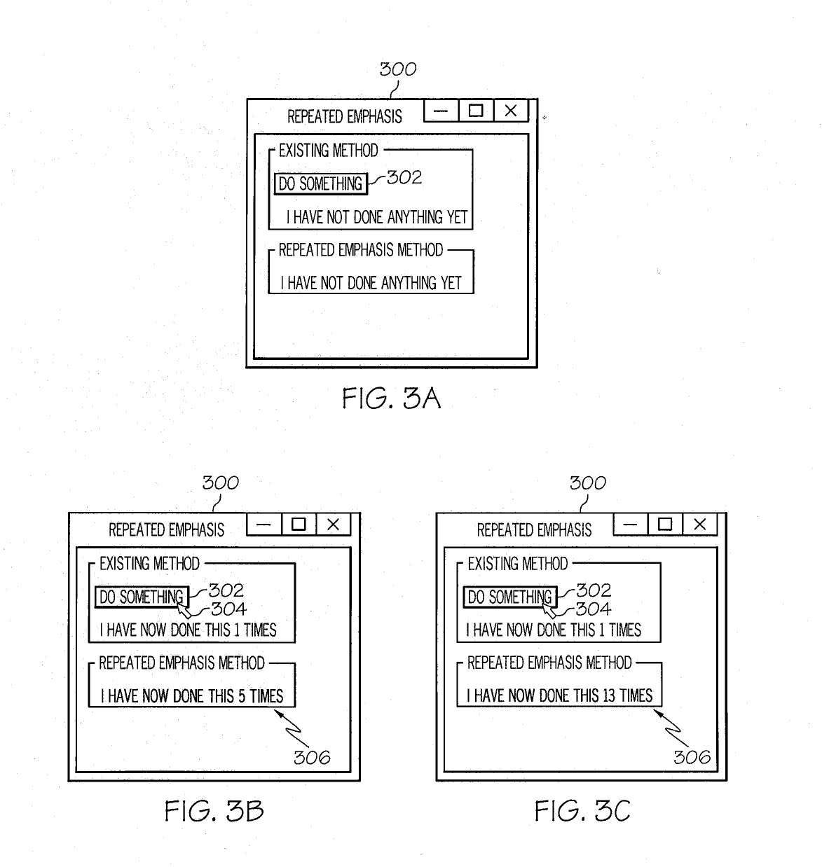

FIGS. 3A-3C are an illustration of an example of repeated emphasis of a component in a user interface 300 in accordance with an embodiment of the present invention. FIGS. 3A-3C illustrate a user interface widget 302 or component in the user interface 300 which may be selected for repeated emphasis or target emphasis to allow an operation to be performed in a repeated manner automatically without the user having to physically or manually repeat the operation. FIG. 3A illustrates the user interface 300 without the component or interface widget 302 being selected by a mouse hover event or other event for selecting the interface widget 302 for repeated emphasis or target emphasis.

In FIG. 3B, the mouse represented by arrow 304 has been positioned over the component or user interface widget 302 illustrating a mouse hover event. The repeated emphasis is performed while the mouse 304 hovers over the user interface widget 302. As illustrated in FIG. 3B the results 306 of the repeated emphasis are presented in the user interface 300. As the mouse 304 continues to hover over the user interface widget 302, the results 306 will be continuously updated as illustrated in FIG. 3C. When the mouse 304 is moved from being over the user interface widget 302, the repeated emphasis operation will stop or exit.

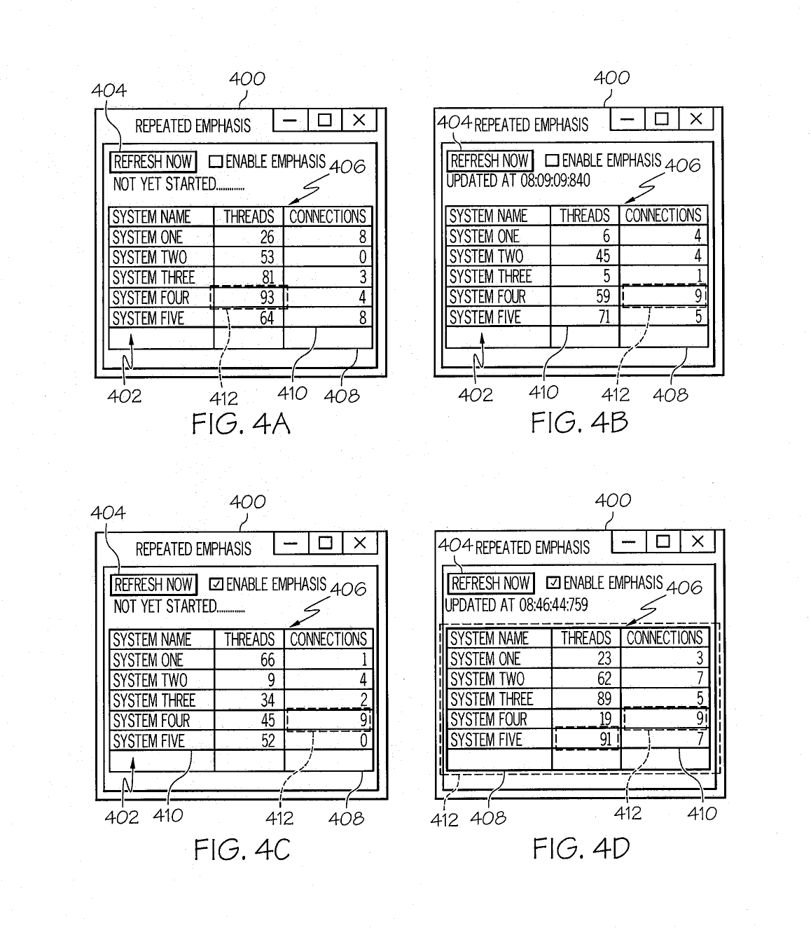

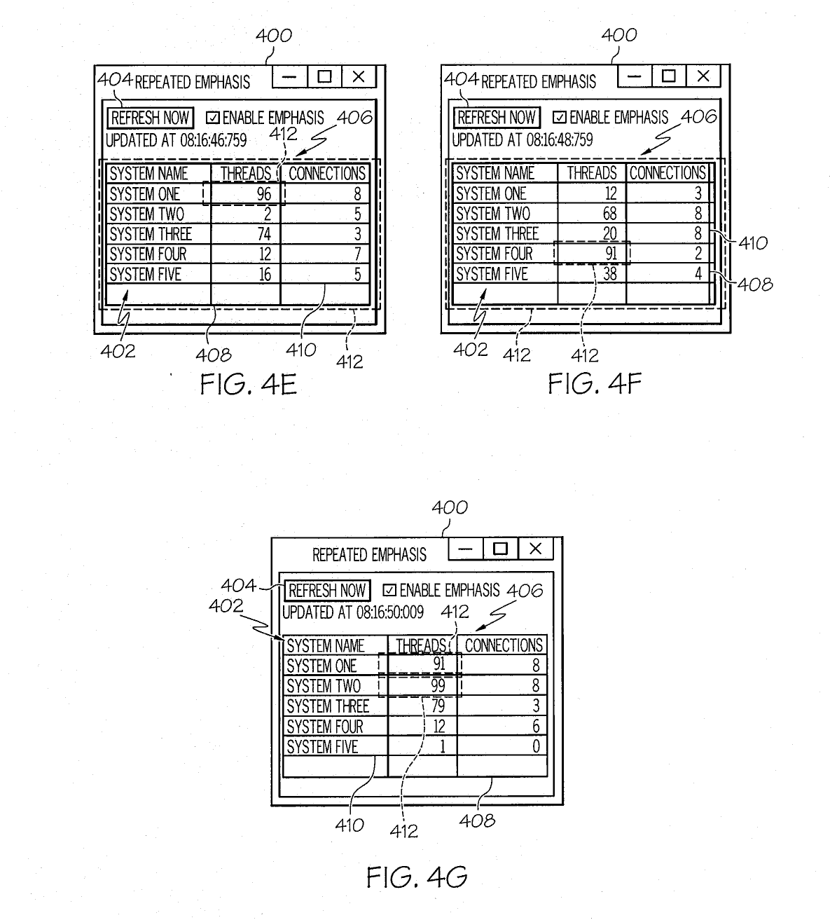

FIGS. 4A-4G are an illustration of another example of repeated emphasis of a component or components in a user interface in accordance with an embodiment of the present invention. The user interface 400 in each of the Figures may illustrate statistics related to different systems 402 being returned from a server or other device and being presented in a table. Without the features of the present invention as described herein, a user would have to continuously operate a “Refresh now” button 404 or similar mechanism to continuously refresh or update the displayed data or results 406. In systems where data or information may be changing at a very high velocity or frequency, the user will be unable to operate the “Refresh now” button 404 or other mechanism needed to effectively to keep up with the updated data to observe how the results 406 or information may be changing and to also observe at what velocity or frequency the data may be changing. The present invention as described herein allows the repeated emphasis or targeted emphasis feature to be applied to the “Refresh now” button 404 or other mechanism in other user interfaces to automatically operate the button 404 or other mechanism to constantly refresh or update the results 406. The repeated emphasis or targeted emphasis feature may also be configured as described herein to permit the button 404 or other mechanism to be automatically operated at substantially the same frequency at which the results may be changing or at some other chosen frequency to permit observation of the changes in the data or other information. Thus, the user may concentrate his focus on the results without having to be concerned with continually operating the button 404 or other mechanism and the user is not distracted from observing the results 406.

Components in the user interface may have emphasis enabled for specifically observing changes in data or results. In the example illustrated in FIGS. 4A-4G components are illustrated as a table 408 and cells 410 in the table 408. In accordance with embodiments of the present invention, components may be any elements in a user interface to which the repeated emphasis or targeted emphasis feature described herein may be associated or applied. A desired function or operation may be programmatically associated with an action of a cursor over a selected component or components, such as the table 408 or particular cells 410, to perform a desired function or operation in association with the selected component or element. For example, the table 408 or certain cells 410 may be selected using a cursor or other mechanism, as illustrated by the broken lines 412 for associating or applying the repeated or targeted emphasis. Similar to that previously described, the selected cell or cells may be identified, such as by highlighting or other means, as represented by the broken lines 412, to distinguish the selected cells for repeated or targeted emphasis from non-selected cells. As previously discussed, the repeated emphasis or targeted emphasis application may be configured to programmatically associate the desired function or operation in association with a cursor and to apply or associate the desired function or operation to a component when the cursor is over or associated with the selected component. The function or operation is then repeated as long as the cursor or other mechanism is over the selected component and stops in response to the cursor or other mechanism being removed. In the example illustrated in FIGS. 4A-4G refreshes or updates are happening every 0.25 seconds. The repeated emphasis or targeted emphasis application may be configured to enable and disable operation of selected components using focus of a computer pointing device or mouse focus, cursor focus, or a combination of both or some other mechanism or combination of mechanisms.

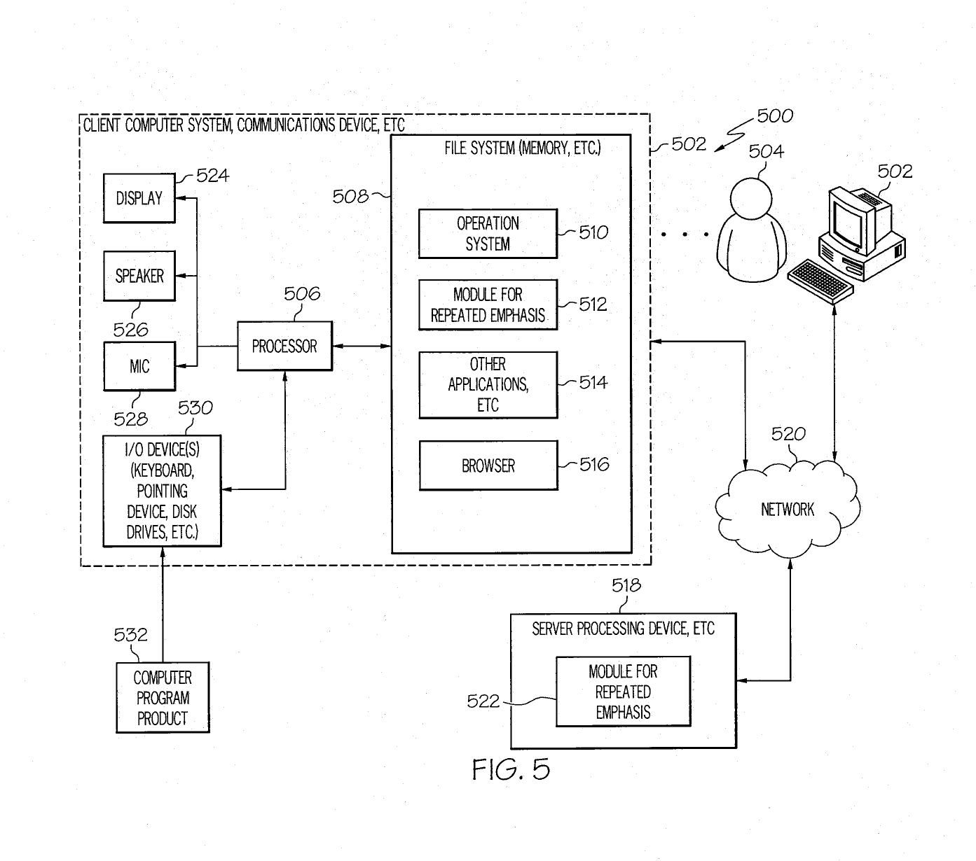

FIG. 5 is a block schematic diagram of an example of a system 500 for repeated emphasis of a component in a user interface in accordance with an embodiment of the present invention. The methods 100 and 200 and other exemplary features described herein with reference to FIGS. 1-4G may be embodied in or performed by the system 500 or components of the system 500 as described below. The system 500 may include a computer system 502 for use by a user 504 for performing the repeated emphasis or targeted emphasis features or operations similar to those described herein. The computer system 502 may be any type of computer device capable of performing the functions or operations described herein.

The computer system 502 may include a processor 506 to control operation of the computer system 502 and a file system 508, memory or similar data storage device. An operating system 510 may be stored on the file system 508 for running or operating on the processor 506. A module 512 for repeated emphasis or targeted emphasis may be stored on the file system 508 for operation on the processor 506 to perform the functions and operations described herein. The methods 100 and 200 and operations described herein may be embodied in the repeated emphasis module 512. Other applications 514, software programs or the like may also be stored on the file system 508 for operation on the processor 506. A web or Internet browser 516 may also be stored on the file system 508 for accessing one or more resources, such as a server 518 via the network 520. The network 520 may be the Internet, intranet or other network.

In accordance with an embodiment, the server 518 or processing device may include a module 522 for repeated emphasis. The module 522 for repeated emphasis may be the same as the module 512 on computer system 502. The repeated emphasis module 522 on the server 528 may be provided in addition to the repeated emphasis module 512 on the computer system 502. In another embodiment, only the repeated emphasis module 522 on the server 518 may be provided, such as in a cloud computing environment or similar arrangement. The repeated emphasis module 522 would then be accessed via the network 520 using the browser 516 of the computer system or computing device 502. In a further embodiment, repeated emphasis module 512 on the computer system 502 may perform some of the operations described herein and repeated emphasis module 522 on the server 518 may perform other functions described herein.

The computer system 502 may also include a display 524 for presenting user interfaces, graphical displays as well as other content. The computer system 502 may also include a speaker system 526 for presenting any audio content. The computer system 502 may additionally include a microphone 528 for the user 504 to aurally communicate via the computer system 502 or control the computer system 502 via voice commands.

The computer system 502 may further include one or more input devices, output devices or combination input/output devices, collectively I/O devices 530. The I/O devices 530 may include a keyboard, pointing device, such as a mouse or other computer pointing device, disk drives and any other devices to permit a user, such as user 504, to interface with and control operation of the computer system 502 and network resources, such as server 518. The repeated emphasis module 512 may be loaded on the computer system 502 from a computer program product, such as computer program product 532 using one of the input devices 530. The computer program product 532 may be embodied in a form similar that previously described.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for repeated emphasis of a component in a user interface, comprising:
selecting, by a processor, at least one component in a user interface for target emphasis for performance of a repeated emphasis; and
performing, by the processor, the repeated emphasis on the at least one selected component, performing the repeated emphasis comprising automatically, repeatedly performing an action associated with the selected component without a user input, wherein each action would require the user input without the repeated emphasis being performed.

2. The method of claim 1, further comprising discontinuing the repeated emphasis in response to the target emphasis being removed from the at least one component.

3. The method of claim 2, wherein selecting, by the processor, at least one component in the user interface for repeated emphasis comprises positioning a computer pointing device over the at least one component.

4. The method of claim 3, further comprising discontinuing the repeated emphasis in response to the computer pointing device being moved from being over the at least one component.

5. The method of claim 1, wherein selecting, by the processor, at least one component in the user interface for repeated emphasis comprises selecting the at least one component by a hot-key to enable and disable performance of the repeated emphasis on the at least one component.

6. The method of claim 1, further comprising presenting a feature for selecting a frequency for performing the repeated emphasis on the at least one selected component.

7. The method of claim of claim 1, further comprising presenting an option for reporting results of the repeated emphasis.

8. The method of claim 1, further comprising presenting results of the repeated emphasis to a user.

9. The method of claim 8, wherein presenting the results of the repeated emphasis comprises updating the results at a chosen interval relative to each repeated emphasis.

10. The method of claim 9, further comprising updating the results after performance of each repeated emphasis.

11. The method of claim 1, wherein the at least one component selected for repeated emphasis is adapted to accept the target emphasis for the repeated emphasis to be performed in association with the at least one component.

12. The method of claim 1, further comprising presenting a feature to confirm selection of the at least one component for the target emphasis.

13. The method of claim 1 further comprising indentifying the at least one component selected for repeated emphasis in response to the selection of the at least one component being confirmed.

14. The method of claim 1, wherein performing the repeated emphasis comprises performing the repeated emphasis based on the selected at least one component and a configuration of a repeated emphasis application that performs the repeated emphasis.

15. A system for repeated emphasis of a component in a user interface, comprising:
a processor;
an application operating on the processor, the application comprising:
a module for selecting at least one component in a user interface for target emphasis for performance of a repeated emphasis, and
a module for performing the repeated emphasis on the at least one selected component, performing the repeated emphasis comprising automatically, repeatedly performing an action associated with the selected component without a user input, wherein each action would require the user input without the repeated emphasis being performed.

16. The system of claim 15, wherein the repeated emphasis is discontinued in response to the target emphasis being removed from the at least one component.

17. The system of claim 15, further comprising a module for selecting a frequency for performing the repeated emphasis on the at least one selected component.

18. A computer program product for repeated emphasis of a component in a user interface, the computer program product comprising:
a computer readable storage medium having computer readable program code embodied therewith, the computer readable program code comprising:
computer readable program code configured to select at least one component in a user interface for target emphasis for performance of a repeated emphasis; and
computer readable program code configured to perform the repeated emphasis on the at least one selected component, performing the repeated emphasis comprising automatically, repeatedly performing an action associated with the selected component without a user input, wherein each action would require the user input without the repeated emphasis being performed.

19. The computer program product of claim 18, further comprising computer readable program code configured to select a frequency for performing the repeated emphasis on the at least one selected component.

20. The computer program product of claim 18, further comprising computer readable program code configured to present the results of the repeated emphasis to a user at a chosen interval relative to each repeated emphasis.
